(19) United States
(12) Patent Application Publication
(10) Pub. No.: US 2005/0173202 A1
(43) Pub. Date: Aug. 11, 2005

(54) Hoistable overhead storage system

(76) Inventor: David Wilson Shaw, Chilliwack (CA)

Correspondence Address: KOLISCH HARTWELL, P.C., 520 S.W. YAMHILL STREET, SUITE 200, PORTLAND, OR, 97204, US

(21) Appl. No.: 10/773,645

(22) Filed: Feb. 6, 2004

(51) Int. Cl. B66B 7/00

(52) U.S. Cl. 187/414

(57) ABSTRACT

Storage apparatus for storing and organizing parts which is particularly suited for use in business that service and repair an automobiles. The apparatus includes a container and a support structure to support the container. A carriage connected to the container and movable with respect to the support structure acts to move the container between a loading position and a storage position on activation of an actuator mechanism preferably in the form of a manual hoist. When the support structure comprises a vertical post, the apparatus allows for storage of parts in an overhead position, out of the way in order to maintain a clean and safe work site, yet readily accessible by a user.

### FIELD OF THE INVENTION

This invention relates to apparatus for storing articles, and more particularly, to a storage bin useful in automobile service and repair work that can be moved between a raised working position for loading and access to articles such as tools and automotive body parts, and raised to a stored overhead position for holding loaded articles.

### BACKGROUND OF THE INVENTION

Businesses that service and repair automobiles such as autobody shops, oil and fluid change locations, muffler and brake shops, general garages, paint shops and the like are often organized along the lines of one or more vehicle bays or stations in which a vehicle being worked on is parked. Tools and equipment for working on the vehicle are associated with each work bay. When work is being performed on a vehicle, it is important in the interest of efficiency and orderliness to keep parts stored and organized to ensure that they are not lost or mixed up with parts from another vehicle being serviced in another bay. As well, a clean and well organized work station is important for health and safety reasons.

Despite the desirability of a well organized and clean work bay, any storage locations such work benches or shelving in the work bay reduce the available workspace, and therefore, tend to be limited in size. It is not unknown for vehicle parts to overflow the available storage space at a work bay, particularly when major work involving large numbers and/or large sized parts is necessary.

U.S. Pat. No. 5,056,878 to Givens discloses a storage apparatus and method that involves a bin supported above the ground adjacent a vehicle parking spot. The invention is intended primarily to provide additional storage room for personal items for an owner at their parking space in a business or condominium parking lot whether it be an above ground or underground parking facility. The bin is not intended to support a great deal of weight and the raised nature of the bin with a hinged door makes it unsuitable for lifting and storage of heavy automotive body parts.

### SUMMARY OF THE INVENTION

To address the foregoing problems, the present invention provides storage apparatus that permits parts from an automobile being worked on in a work bay to be stored in a single location to keep the parts organized and the work bay clean. The apparatus permits raised storage of the parts out of the way but still readily accessible so that the work station is maintained clutter free and save.

Accordingly, the present invention provides a storage apparatus comprising:
a container;
a support structure to support the container;
a carriage connected to the container and movable with respect to the support structure to move the container between a loading position and a storage position; and
an actuator mechanism to control movement of the carriage.

In a preferred arrangement, the storage apparatus relies on a vertical post as the support structure and a manual hoist as the actuator mechanism to move the container between a lowered loading position and a raised storage position.

### BRIEF DESCRIPTION OF THE DRAWINGS

Aspects of the present invention are illustrated, merely by way of example, in the accompanying drawings in which:

FIG. 1 is a side elevation view of the storage apparatus of the present invention according to a preferred embodiment in which the container is stored in an overhead storage position;

FIG. 2 is a end elevation view of the apparatus of FIG. 1;

FIG. 3 is a bottom view taken along line 3-3 of FIG. 1;

FIG. 4 is a detail view taken along line 4-4 of FIG. 3 showing details of the carriage with one of the plate members removed;

FIGS. 5a and 5b are schematic views showing the apparatus in lowered and raised positions, respectively; and

FIGS. 6a and 6b are schematic views of alternative actuator mechanisms for use with the storage apparatus of the present invention.

### DESCRIPTION OF THE PREFERRED EMBODIMENTS

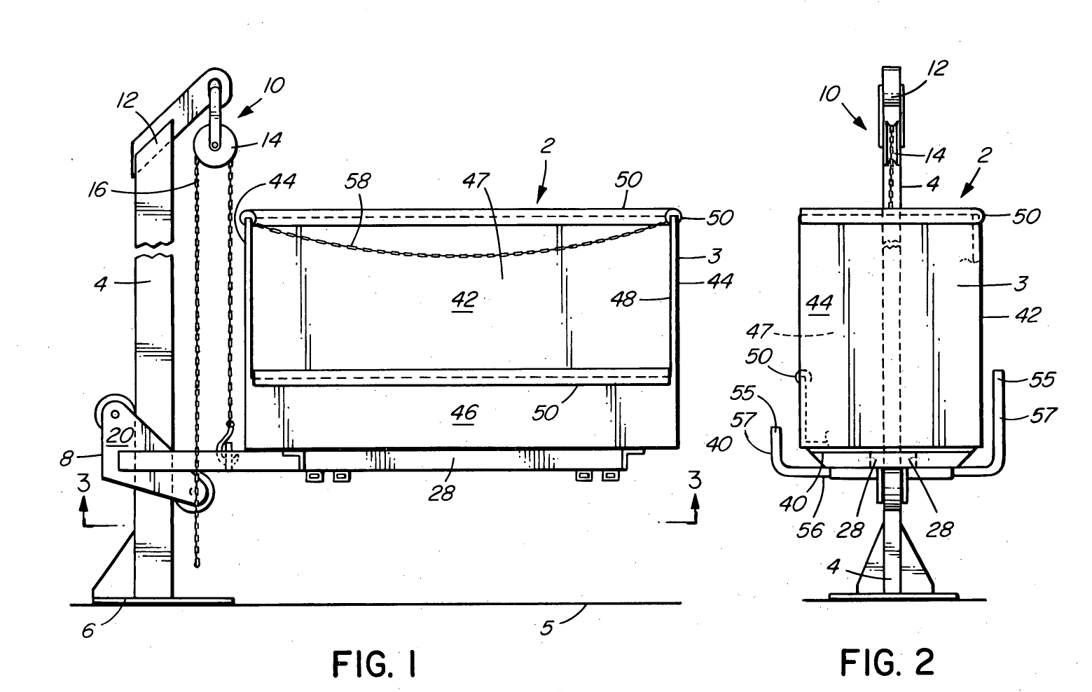

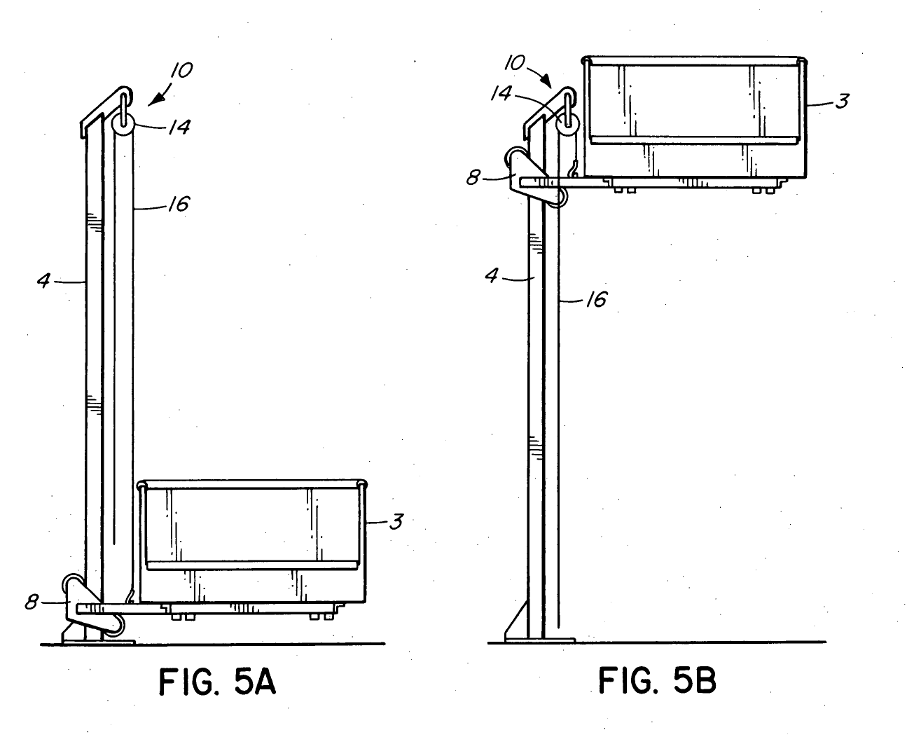

Referring to FIGS. 1 and 2, there is shown a preferred embodiment of the storage apparatus 2 of the present invention. In the illustrated embodiment, the storage apparatus comprises a container 3 in which articles are stored that is movably mounted to a support structure in the form of a vertical post 4. Post 4 is preferably a steel post of rectangular cross-section and is mounted to a floor surface 5 or other fixed surface via base plate 6. For example, base plate 6 may be bolted to a cement floor with multiple epoxy anchors. A carriage 8 connected to container 3 is movable with respect to post 4 to move the container between a lowered loading position and a raised storage position as best shown in FIGS. 5a and 5b, respectively. Movement of carriage 8 and attached container 3 along post 4 is controlled by an actuator mechanism. In the illustrated embodiment, the actuator mechanism comprises a manual hoist 10 mounted to the upper end 12 of post 4. The manual hoist includes a pulley assembly 14 and a line 16 about the pulley assembly that extends to the floor surface 5 to allow for manipulation by a user on the floor. Line 16 is preferably a chain having an end 18 connected to the carriage such that can manipulate the chain to move the carriage along the post. Pulley assembly 14 is selected to provide an appropriate mechanical advantage to allow a user to comfortably raise and lower carriage 8 and container 3 when fully loaded with parts. By way of example, in prototype testing, a container 3 and carriage 8 engineered to carry up to 400 pounds were found to provide useful storage capacity that required a half ton manual chain hoist for movement. Post 4 was dimensioned to raise container 3 to an overhead clearance of approximately 9 feet with respect to floor surface 5.

The manual hoist arrangement illustrated permits container 3 to be positioned at intermediate positions as shown in FIG. 1 between the lowered and raised positions of FIGS. 5a and 5b. Chain 16 can be tied off on post 4 to hold the carriage at a desired location or pulley assembly 14 may include a conventional pawl and ratchet system to hold the carriage at whatever position it is raised to along post 4.

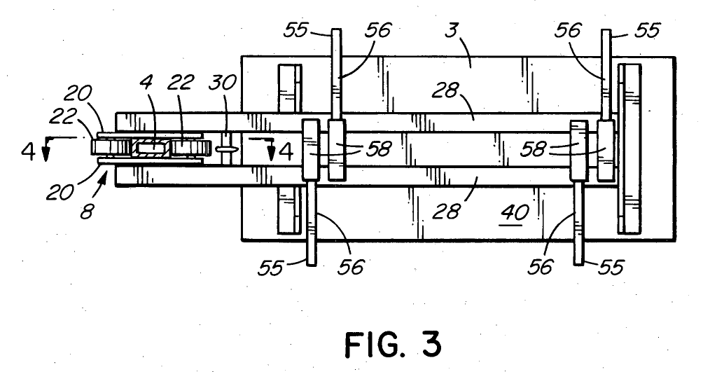

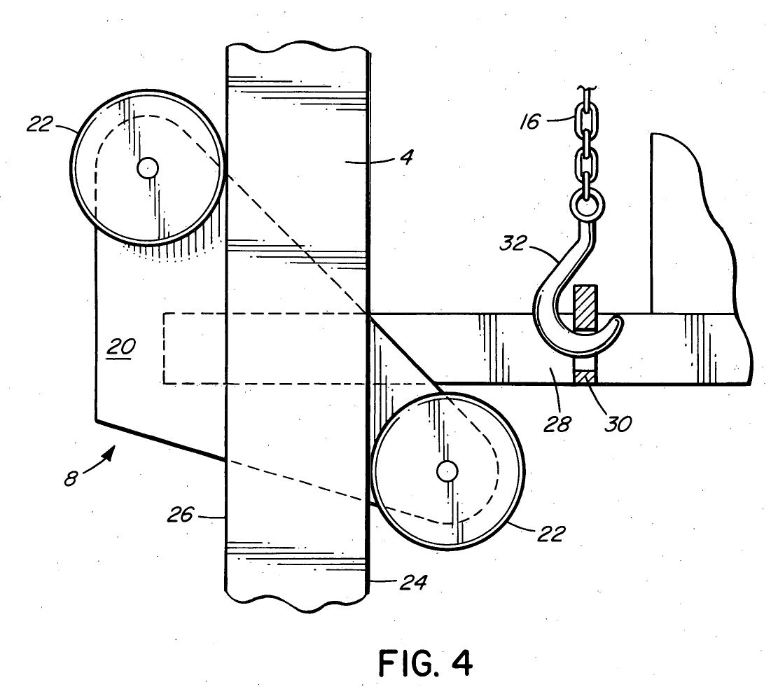

FIGS. 3 and 4 are views that show details regarding the preferred construction of carriage 8. As best shown in FIG. 3, which is a bottom view of the apparatus taken along line 3-3 of FIG. 1, carriage 8 is formed from a pair of spaced plate member 20 positioned on opposite sides of post 4 (shown in cross-section in FIG. 3) to define a platform for supporting container 3. FIG. 4 is a detail view taken along line 4-4 of FIG. 3 showing the carriage with one of the plates removed. At least one roller 22 is rotatably mounted between the spaced plates to engage a side of post 4 to permit slidable movement of the carriage along the post. In the illustrated embodiment, two high pressure rollers are mounted between plates 20 on opposite sides of post 4 to engage opposite sides 24 and 26 of the post to transfer the load of container 3 to the vertical steel post. The flat, planar sides 24 and 26 of post 4 define surfaces that guide movement of the carriage between the loading and storage positions of the container. While the above-described carriage provides a sturdy yet lightweight vehicle for movement along post 4 in order to move container 3 between the lowered loading position and the raised storage position, it will be appreciated that other carriage designs are possible and within the scope of the present invention. For example, the carriage can comprises a sleeve that encircles post 4 with at least one roller engaging the post to facilitate slidable movement of the sleeve along the post.

In the embodiment of the carriage illustrated in the Figures, the pair of carriage plates 20 support at least one beam 28 extending from the plates in a cantilever arrangement that defines a platform to which container 3 is mounted. In the illustrated preferred embodiment, each plate member 20 has a separate attached beam 28 such that the platform for supporting container 3 is formed from a pair of spaced, parallel beams as best shown in FIG. 3. Other arrangements of a beam or beams extending from plates 20 for supporting container 3 are possible and will be apparent to a person skilled in the art. Beams 28 are preferably of tubular steel frame construction which offer strength and weight advantages.

In the illustrated carriage, rollers 22 are vertically offset from each other on opposite sides of post 4 and the pair of cantilevered beams 28 are mounted to plates 20 such that the weight of the container on beams 28 exerts a torque force on the carriage (in a clockwise direction as shown in FIG. 4) that tends to bias the pair of offset rollers 22 into engagement with the sides of the post.

FIGS. 3 and 4 also show a preferred anchor point for attaching a hook 32 at the end of chain 16 to the carriage. The anchor point comprises a bar 30 extending between spaced, parallel beams 28. Bar 30 provides a convenient, readily accessible location to attach a first end of chain 16 to the carriage platform to permit movement of the carriage and attached container with pulley arrangement 14 by pulling on the second end of chain 16.

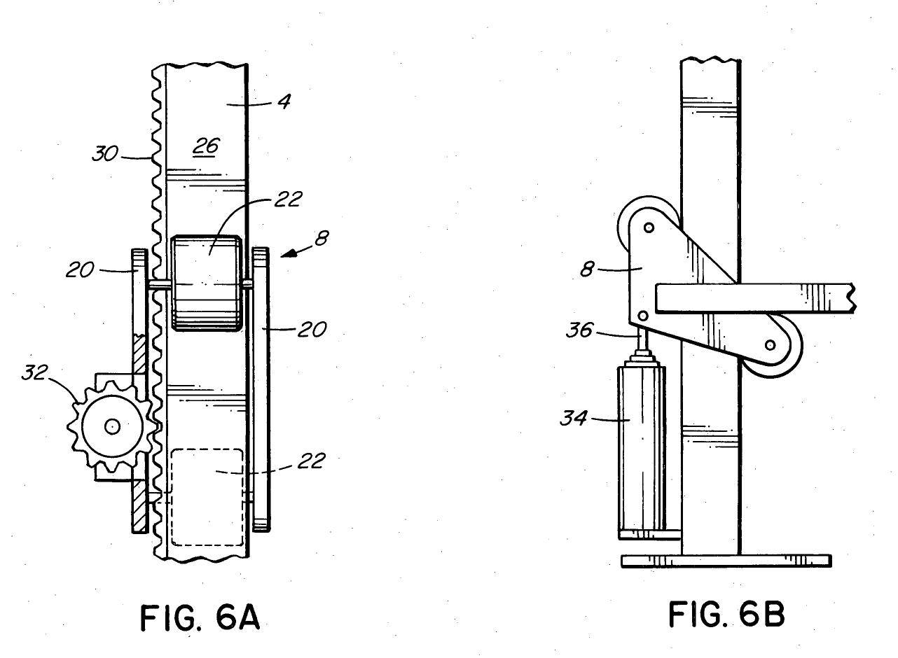

While the illustrated pulley arrangement 14 provides a convenient and reliable means for raising and lowering container 3 on post 4, it will be appreciated that other actuator mechanisms are possible. For example, FIG. 6a illustrates an alternative arrangement in which a side surface of post 4 is formed with a rack 30 that is engageable by a gear 32 associated with carriage plate 20. Rotation of gear 32 by a suitable drive means such as a motor or hand crank will move carriage 8 along post 4. Other arrangement are also possible. For example, FIG. 6b shows an arrangement involving a hydraulic or pneumatic cylinder 34 extending between a fixed location on post 4 and moveable carriage 8 to move the carriage along the post on adjustment of the length of cylinder by extending or retracting cylinder piston 36. Cylinder 34 can also be mounted to floor 5.

Referring again to FIGS. 1 and 2, container 3 is preferably formed from sheet metal and comprises a box structure having a base 40, an upstanding rear wall 42, a pair of upstanding, opposed end walls 44, and an upstanding front wall 46 to define an interior region 47 above base 40 for holding articles to be stored. Preferably, front wall 46 has a section that is lower than the end walls to define an opening 48 for access to the interior region. The exposed upper edges of the container walls are preferably finished with a foam tube 50 or other suitable covering material. The container walls are preferably bolted together along their edges to permit collapsing of the box for shipping and transport purposes. Base 40 of container 3 is mounted to beams 28 by bolting or other suitable fasteners. Alternatively, the container walls and base box walls can be stitch welded together along the inside corners. In prototype testing, a container having a length of 4 to 6 feet, a height of 3 feet and a width of 2 feet was found to provide adequate storage space for most automotive parts. A chain 58 suspended between the top edges of end walls 44 and extending across opening 48 is also provided to ensure that larger articles are safely retained within container 3.

As best shown in FIGS. 2 and 3, the storage apparatus of the present invention preferably includes rails 55 below the container to receive and support additional lightweight, but bulky articles such as automobile body panels that may be too large to be stored efficiently in the interior of container 3. Rails 55 include an elongate, straight portion 56 and a hooked end 57, and are preferably arranged in pairs on either side of container 3. A body panel can be rested between a pair of rails 55 on the straight portions with the hooked ends providing a stop to retain the body part on the rails. In a preferred arrangement, straight portions 56 of each rail 55 are telescopically received in sleeves 58 attached to the bottom of beams 28 to permit rails 55 to be extended for use or retracted out of the way as needed.

The foregoing discussion of the storage apparatus of the present invention has described a system that relies on vertical movement of the carriage and container along a vertically aligned post. It is within the scope of the present invention that the carriage and container can move other than in a substantially vertical direction to move the container between the loading position and the storage position. For example, post 4 may be aligned horizontally and carriage 8 can be movable horizontally between a loading position at a work station and a storage position at a location removed from the workstation.

Although the present invention has been described in some detail by way of example for purposes of clarity and understanding, it will be apparent that certain changes and modifications may be practised within the scope of the appended claims.

1. Storage apparatus comprising:
a container;
a support structure to support the container;
a carriage connected to the container and movable with respect to the support structure to move the container between a loading position and a storage position; and
an actuator mechanism to control movement of the carriage.

2. The storage apparatus of claim 1 in which the support structure includes at least one surface to guide movement of the carriage between the loading and storage positions of the container.

3. The storage apparatus of claim 2 in which the support structure comprises a post and the at least one surface to guide movement of the carriage comprises a side of the post.

4. The storage apparatus of claim 3 in which the carriage comprises:
a pair of spaced members positionable on opposite sides of the post to define a platform for supporting the container;
at least one roller rotatably mounted between the spaced members to engage the side of the post to permit slidable movement of the carriage along the post.

5. The storage apparatus of claim 4 in which the post is substantially vertical and the carriage includes two rollers on opposite sides of the post to engage sides of the post.

6. The storage apparatus of claim 5 in which the rollers are vertically offset from each other.

7. The storage apparatus of claim 6 in which each spaced member comprises a plate, the pair of plates supporting at least one beam extending from the plates in a cantilever configuration to define the platform to support the container whereby the container exerts a force on the plates that tends to bias the offset rollers into engagement with the sides of the post.

8. The storage apparatus of claim 1 in which the container comprises:
a box structure having a base, an upstanding rear wall, a pair of upstanding, opposed end walls, and an upstanding front wall to define an interior region for holding article to be stored, the front wall having a section that is lower than the end walls to define an opening for access to the interior region.

9. The storage apparatus of claim 1 including rails below the container to receive and support articles to be stored.

10. The storage apparatus of claim 9 in which the rails are extendable from a stowed position below the container to an extended position to receive support articles to be stored.

11. The storage apparatus of claim 10 in which the rails are configured to telescope between the stowed and extended positions.

12. The storage apparatus of claim 1 in which the actuator mechanism comprises a manual hoist mounted to the support structure and connected to the carriage to move the carriage with respect to the support structure.

13. The storage apparatus of claim 1 in which the actuator mechanism comprises an extendable cylinder mounted between the carriage and the support structure whereby adjusting the length of the cylinder acts to move the carriage along the support structure.
